(19) United States
(12) Patent Application Publication
(10) Pub. No.: US 2002/0053303 A1
(43) Pub. Date: May 9, 2002

(54) Titanium dioxide pigment composition

(76) Inventor: Jeffrey F. Krizan, Southbury, CT (US)

Correspondence Address: REED SMITH LLP, 375 PARK AVENUE, NEW YORK, NY, 10152, US

(21) Appl. No.: 09/975,806

(22) Filed: Oct. 11, 2001

Related U.S. Application Data
(60) Provisional application No. 60/240,190, filed on Oct. 11, 2000.

(51) Int. Cl. C09C 1/36

(52) U.S. Cl. 106/449

(57) ABSTRACT

A pigment composition composed of titanium dioxide and barium sulfate, wherein the barium sulfate being is in a titanium dioxide stabilizing and anti-agglomeration effective amount. Methods for use and products using the composition are also disclosed.

### CROSS REFERENCE TO RELATED APPLICATION

This application is based on and claims priority from U.S. Provisional Patent Application Ser. No. 60/240,190, filed Oct. 11, 2000.

### BACKGROUND

1. Field of the Invention

This invention relates to the field of TiO₂ pigment compositions. More particularly, this invention pertains to pigment compositions composed of TiO₂ and barium sulfate in amounts which provide enhanced opacity and brightness to substrates containing the compositions.

2. Background of the Invention

TiO₂ is a white pigment which has a high index of refraction and excellent light diffusing properties. It is used as a pigment for various substrates, such as, plastics, paper and coating compositions, including paints. See, for example, U.S. Pat. No. 6,267,812, the contents of which are incorporated herein by reference.

TiO₂ is generally found in two different crystalline forms referred to as anatase and rutile. Both forms may be used as an opacifying agent for a variety of substrates. The TiO₂ may be mixed with water to form a slurry which can be incorporated into or onto the substrate by mixing with the particular material making up the substrate or coating onto the surface of the substrate. Alternatively, for use in non-aqueous systems, such as a plastic or polymeric substrate, the TiO₂ may be added directly to the substrate in a suitable form as is well known in the art.

However, TiO₂ presents a number of problems with respect to its use. Specifically, it is relatively expensive and exhibits a propensity to undergo autoflocculation; namely, it agglomerates both in the dry state as well as when slurried in water which makes it difficult to maximize its opacifying capacity (See U.S. Pat. No. 5,705,033.)

In order to ameliorate such problems, TiO₂ has been mixed with other pigment materials, e.g., cationic polymers, saccharides, siloxanes, kaolin; clays, and the like. However, the addition of such materials deteriorates the capability of the TiO₂ with respect to its opacification properties and generally have only partially alleviated the agglomeration problem.

Barium sulfate is a white water insoluble compound which has also been used in pigment compositions, or x-ray contrast agents. It may be obtained in a natural state as well as synthetically as a material known as blanc fixe. However, it does not exhibit significant opacification properties but does provide “brightness” to compositions to which it is added.

For purposes of this application, the terms “opacity” or “opacifier” relate to the ability or property of being or rendering a substrate impervious to light rays so that it not transparent. Thus, with respect to TiO₂ having opacifier or opacification properties, it is meant that when applied onto or incorporated into a substrate, it increases blockage of light rays.

As used herein, the term “brightness” or “brightening” refers to the ability of a material to reflect light thereby increasing its intensity. Thus, generally, it is perceived as light which is reflected from a surface.

### SUMMARY OF THE INVENTION

I have discovered that the above disadvantages of TiO₂ compositions can be decreased by the use of a pre-prepared composition composed of titanium dioxide and barium sulfate wherein the amount of barium sulfate is sufficient to prevent the agglomeration of the TiO₂. Moreover, I have discovered that the addition of this anti-agglomeration effective amount of barium sulfate does not detract from the opacification properties of the TiO₂ and in addition, assists in providing brightness characteristics to the overall pigment composition.

Either rutile or anatase TiO₂ may be used in the inventive composition. The barium sulfate may be in the form of naturally obtained barium sulfate, i.e., natural barytes, or synthetic barium sulfate, namely, blanc fixe.

The inventive composition may be provided either as a dry mixture or in the form of a slurry which may then be diluted or used as is for the particular substrate to be opacified.

### DETAIL DESCRIPTION OF THE INVENTION

The pigment composition of the present invention contains titanium dioxide and barium sulfate wherein the amount of barium sulfate is sufficient and effective to reduce the agglomeration of the titanium dioxide when the composition is formed into an aqueous slurry.

As used herein, the “total solids content” means the weight of all components in the absence of water. This is sometimes referred to as the dry weight of the composition. Generally, the pigment composition of the present invention as a slurry has a total solids content or dry weight in the range from about 65.0 to 80.0, and preferably is from about 70.0 to 73.0 percent by weight based on the total weight of the slurry composition.

Particularly, I have found that the effective amount of barium sulfate may be added to the composition in accordance with the invention amounts from about 5.0 up to about 35.0 percent by weight based on the weight of the total solids of the composition and the amount of TiO₂ may be in the range from about 95.0 to 65.0 percent by weight based on the weight of the total solids of the composition. Thus, even at levels of about 5.0 percent by weight, an economic advantage can be realized by virtue of the decreased amount of TiO₂ in the composition. At barium sulfate levels above about 35.0 percent by weight, the opacifying capacity of the TiO₂ in the composition begins to decrease. However, the effects on the opacifying properties of the TiO₂ may also be dependent on the particular substrate so that, in certain substrates and/or end uses, the opacifying capability of the TiO₂ may be satisfactory even at barium sulfate levels above 35.0 percent by weight.

Preferably, the amount of barium sulfate is in the range from about 30.0 to 24.0 percent by weight and the TiO₂ is in the range from about 70.0 to 76.0 percent by weight based on the total weight of the solid content of the composition.

The composition may further contain conventional additives of the type which are well known in the art. Typically, these may constitute materials which are defoamers, dispersants, biocides, pH adjustment agents and a combination of these ingredients. One skilled in this art is well aware of all of the various types of additives which may be utilized and usually, the nature and type of additive used depends on the specific end use of the pigment composition and the particular substrate in which it will be used.

Preferably, an additive is used in an amount from about 0.5 to 3 percent by weight, based on the weight of the total solids of the composition.

Typical additives which may be utilized in the inventive composition include materials, such as, dimethyl polysiloxane, octamethylcyclotetresiloxane, anionic polyacrylate, polyglycolethers, fumed silica ethers, petroleum hydrocarbons, acrylic polymers, triethanolamine, bicyclic oxazolidines, 1,2-benzisothiazolin-3-on, sodium hydroxide as well as combinations of these ingredients.

A particularly preferred composition for use in opacification of paper products is composed of from about 74.5 to 75.5 percent by weight of titanium dioxide and from about 24.5 to 25 percent by weight blanc fixe, the weights being based on the total solids weight of the composition. In this particularly preferred embodiment, the composition is in the form of an aqueous slurry having a total solids content in the range from about 71.0 to 72.9 percent by weight based on the total weight of the slurry composition.

The inventive composition preferably, in aqueous slurry form, has a pH of from about 7.0 to 10.0, a maximum 325 sieve residue of fifty parts per million, and a Brookfield viscosity of about 200 to 800 as measured with a #4 spindle at 100 rpm at ambient temperature.

The inventive composition may be mixed in a dry state and sold as a powder for subsequent slurrying or slurried in water and sold in this form. Typical uses for the inventive composition are in the manufacture of a variety of substrates in order to increase their opacity and brightness. As used herein the word “substrates” refers to those materials which generally require some level of opacification for their ultimate end use. These substrates may be in a variety of forms such as films, sheets, shaped elements, e.g., shaped components for use in machinery, household goods, toys, automobiles, aircraft, and the like. The substrates generally may be composed of papers, plastics as well as a variety of coatings in which pigments are generally used, for example, paints, inks and stains.

The inventive composition is particularly suitable for use in the paper industry wherein it is mixed with the pulp at some point during the conventional paper making process. In addition, the inventive composition may also be coated onto paper at an appropriate point in the paper making process. In the same manner, it may be used as a coating for the other aforementioned substrates in order to create an opacifying layer thereon. One skilled in this art fully understands how to use such a pigment composition in connection with the particular product with which that person is dealing. No special techniques are required for use of the inventive pigment composition and conventional procedures may be utilized in all respects.

The inventive composition exhibits a unique effect of dispersing the titanium dioxide particles and maintaining their separation as a result of the spacing provided by the barium sulfate when the composition is formed into an aqueous slurry. This makes the composition particularly suitable for use in paper coatings and wet end paper applications.

The inventive composition provides a number of additional advantages in particular in manufacture of paper as follows:

1. It provides increased retention of the inventive composition by the substrate.

2. The invention allows for the use of higher amounts of increased solids in a slurry which lowers the transportation cost.

3. The viscosity of the inventive slurry is improved to facilitate handling both in tank truck or rail car loading and unloading using pumping systems.

4. The inventive composition allows paper producers to use a choice of fillers for the paper beyond the normal array of clay materials in the conventional “acid” process.

5. The inventive composition has a reduced abrasiveness as compared to a 100 percent titanium dioxide composition. This reduces the overall wear in the paper making equipment and a reduction in the abrasiveness of the furnish. Blanc fixe has a hardness rating of 3.0 (moh's) hardness whereas titanium dioxide has a moh's hardness of 5.5 to 7.0. The inventive composition provides increased gloss, i.e., shine, in paper coating or allows increased productivity in the speed of calendaring of the paper while maintaining the same gloss as would have been obtained for the use of a coating which did not contain the inventive composition.

6. Higher relative bulk density is obtained with the present invention which further results in increased paper weight and strength.

The properties of the composition referred to herein above were determined as follows:

### Determination of Total Solids of Inventive Slurry

About 3 g of slurry weighed to the nearest mg were placed in a tared crucible and then dried in a microwave oven at full power for two minutes to remove water. The crucible was then subjected to calcination temperatures to carbonize organics in the composition. The crucible was then cooled and reweighed. The percent of solids was calculated as the dried weight of the crucible contents divided by the wet weight and multiplied by 100.

### Viscosity Determination of the Inventive Composition

A Brookfield viscometer model RV with a #4 spindle was used. A standard one quart retainer sample jar was filled to the top with a sample of the slurry. The sample was then allowed to rest for one hour at ambient temperature. Thereafter, the spindle was inserted until the level of the slurry was at the emersion groove of the spindle shaft. Viscosity measurement was conducted using a standard procedure with a Brookfield viscometer at both 50 and 100 rpm.

### pH Determination of TiO₂ Slurry

A pH meter was utilized capable of measuring the pH to 0.1 units or better was used. The pH meter was checked with buffered reference solutions having a pH of 7 and a pH of 10 and calibration was carried out if necessary. The electrodes were then introduced into the slurry and the slurry was gently agitated to ensure a thorough wetting and the pH was red to the nearest 0.1.

### Determination of 325 Mesh Reside of the Inventive Slurry

Approximately 200 g of the slurry was weighed into a tared 250 ml beaker weighed to the nearest 0.1 g. The slurry was poured through a 325 mesh sieve using gentle tapping under a stream of water. Any slurry remaining in the beaker was washed out with water onto the screen and then the material under the screen was washed under running water until the sieve ran clear.

The residue on the screen was further washed and transferred to a tared aluminum foil weighing dish using a stream of isopropyl alcohol. The excess isopropyl alcohol was blotted from the dish using a paper towel without disturbing the residue. The contents of the dish were then subjected to drying in a convection oven at 105° C. for about 30 minutes to remove the water therefrom. The dish was removed from the oven, cooled and weighed. If any question existed that the sample had not fully dried, it would be reheated, cooled and reweighed to make sure that no further weight loss occurred. The results were then determined by dividing the weight of the residue by the weight of the initial slurry and multiplying by 1×10⁶ providing results in parts per million. The amount of residue on the 325 mesh must be less than 50 ppm.

What is claimed is:

1. A pigment composition comprising TiO₂ and a TiO₂ stabilizing and anti-agglomeration effective amount of barium sulfate.

2. The composition of claim 1 wherein the barium sulfate is selected from the group consisting of natural barytes.

3. The composition of claim 1 wherein the barium sulfate is synthetic blanc fixe.

4. The pigment composition of claim 1 which is free of water and is in powder form.

5. The pigment composition of claim 1 which further comprises water and is in the form of a slurry.

6. The pigment composition of claim 5 having a total solids content in the range from about 65.0 to 80.0 percent by weight based on the total weight of the composition.

7. The pigment composition of claim 1 wherein the amount of TiO₂ is in the range from about 65.0 to 95.0 percent by weight and the amount of barium sulfate is in the range from about 5.0 to 35.0 percent by weight, all weights being based on the weight of the total solids content of the composition.

8. The pigment composition of claim 7 wherein the amount of TiO₂ is in the range from about 70.0 to 76.0 percent by weight and the amount of barium sulfate is in the range from about 30.0 to 24.0 percent by weight, all weights being based on the weight of the total solids content of the composition.

9. The pigment composition of claim 7 which comprises about 74.5 to 75.5 % by weight TiO₂., and from about 24.5 to 25.5 % by weight blanc fix, all percentages being based on the total solid contents of the composition.

10. The pigment composition of claim 7 wherein the composition further comprises an additive selected from the group consisting of defoamers, dispersants, biocides, pH adjustment agents and combinations thereof.

11. The pigment composition of claim 10 wherein the additive is present in an amount from about 0.05 to 3.0 percent by weight based on the weight of the total solids of the composition.

12. The pigment composition of claim 11 wherein the additive is selected from the group consisting of dimethyl polysiloxane, octamethylcyclotetresiloxane, anionic polyacrylate, polyglycolethers, fumed silica ethers, petroleum hydrocarbons, acrylic polymers, triethanolamine, bicyclic oxazolidines, 1,2-benzisothiazolin-3-on, sodium hydroxide and combinations thereof.

13. The pigment composition of claim 1 which comprises about 74.5 to 75.5 percent by weight of TiO₂ and from about 24.5 to 25.5 percent by weight barium sulfate based on the weight of the total solids content of the composition.

14. The composition of claim 13 in the form of an aqueous slurry having a total solids content in the range from about 71.0 to 72.9 percent by weight based on the total weight of the composition.

15. The composition of claim 13 having a pH of from about 7.0 to 10.0, a maximum 325 sieve residue in parts per million of 50, and a Brookfield viscosity of about 200 to 800 as measured with a #4 spindle at 100 rpm at ambient temperature.

16. The method for increasing the opacity of a substrate comprising adding an opacifying effective amount of the composition of claim 1 to the substrate.

17. A method for increasing the opacity of a substrate comprising adding an opacifying effective amount of the composition of claim 5 to the substrate.

18. A method for increasing the opacity of a substrate comprising: adding an opacifying effective amount of the composition of claim 13 to the substrate.

19. The method of claim 16 wherein the substrate is selected from the group consisting of paper, plastic, and coatings.

20. The method of claim 19 wherein the substrate is in the form of a sheet.

21. The method of claim 19 wherein the substrate is plastic and is in the form of a shaped element.

22. Paper, plastic or a coating containing an opacifying effective amount of the composition of claim 1.
